(19) United States
(12) Patent Application Publication
(10) Pub. No.: US 2021/0148720 A1
(43) Pub. Date: May 20, 2021

(54) VEHICLE ALLOCATION SERVICE PROVIDING DEVICE, VEHICLE ALLOCATION SERVICE PROVIDING METHOD, AND PROGRAM

(71) Applicant: HONDA MOTOR CO., LTD., Minato-ku, Tokyo (JP)

(72) Inventors: Yuji Yasui, Wako-shi (JP); Hisao Asaumi, Wako-shi (JP); Shion Tokunaga, Wako-shi (JP); Masashi Yuki, Wako-shi (JP); Yo Ito, Tokyo (JP); Hirotaka Uchitomi, Tokyo (JP)

(21) Appl. No.: 16/622,006

(22) PCT Filed: Jun. 12, 2018
(86) PCT No.: PCT/JP2018/022326

§ 371 Date: Dec. 12, 2019

(30) Foreign Application Priority Data
Jun. 16, 2017 (JP) 2017-118690

(51) Int. Cl. G01C 21/36; B60W 60/00; G01C 21/34

(52) U.S. Cl. CPC G01C 21/3617; G01C 21/3492; G01C 21/3484; B60W 60/001

(57) ABSTRACT

A vehicle allocation service providing device includes: an acquirer configured to acquire a use request of a main user; an instructor configured to instruct an automated driving vehicle of a route in response to the use request acquired by the acquirer; a route setter configured to set the route of the automated driving vehicle based on the use request and a use request of a user different from the main user; and a service manager configured to allocate a plurality of automated driving vehicles as relays to the main user based on one of a joining plan for the main user and a user different from the main user to use the same vehicle on the route or a branching plan for the main user and the user different from the main user to ride separately into a plurality of vehicles on the route.

### TECHNICAL FIELD

Aspects of the present invention relates to a vehicle allocate service providing device, a vehicle allocate service providing method, and a program.

Priority is claimed on Japanese Patent Application No. 2017-118690, filed Jun. 16, 2017, the content of which is incorporated herein by reference.

### BACKGROUND ART

In the related art, the technology of a boarding system that appropriately supports ridesharing under various situations in consideration of a current situation of a person who wants ridesharing (hereinafter, simply referred to as a “rideshare participant”) and ridesharing providing a vehicle into which the rideshare participant is allowed to utilize has been disclosed (see Patent Literature 1). This system includes information acquisition means for acquiring information regarding a current position of a rideshare participant, vehicle searching means for searching for a vehicle traveling within a predetermined range set using a current position of the rideshare participant as a standard and traveling to the same destination as that of the rideshare participant, and information transmission means for transmitting information regarding the rideshare participant to the vehicle searched for by the vehicle searching means.

### CITATION LIST

### Patent Literature

Patent Literature 1

Japanese Unexamined Patent Application, First Publication No. 2009-289192

### SUMMARY OF INVENTION

### Technical Problem

In the technology of the related art, transfer of a user to a plurality of vehicles is not considered and more efficient administration may not be achieved in some cases.

The present invention is achieved in view of such circumstances and an object of the present invention is to provide a vehicle allocation service providing device, a vehicle allocation service providing method, and a program capable of planning a more efficient service schedule.

### Solution to Problem

A vehicle allocation service providing device, a vehicle allocation service providing method, and a program according to the present invention adopt the following configurations.

(1) According to an aspect of the present invention, a vehicle allocation service providing device includes: an acquirer configured to acquire a use request of a main user;

an instructor configured to instruct an automated driving vehicle of a route in response to the use request acquired by the acquirer; a route setter configured to set the route of the automated driving vehicle based on the use request and a use request of a user different from the main user; and a service manager configured to allocate a plurality of automated driving vehicles as relays to the main user based on one of a joining plan for the main user and a user different from the main user to use the same vehicle on the route or a branching plan for the main user and the user different from the main user to ride separately into a plurality of vehicles on the route.

(2) In the vehicle allocation service providing device according to the aspect (1), the service manager may permit a situation in which a first user occupying at least part of a first automated driving vehicle among the plurality of automated driving vehicles and arriving at a joining location and a second user occupying at least part of a second automated driving vehicle among the plurality of automated driving vehicles and arriving at the joining location share at least part of one automated driving vehicle among the plurality of automated driving vehicles at the joining location.

(3) In the vehicle allocation service providing device according to the aspect (1), the service manager permits a situation and determines a service schedule, the situation being a situation in which the first user occupies at least part of a first automated driving vehicle among the plurality of automated driving vehicles and the second user occupies at least part of a second automated driving vehicle among the plurality of automated driving vehicles at the branching location, the first and the second users being users sharing at least part of one automated driving vehicle among the plurality of automated driving vehicles and arriving at a branching location.

(4) In the vehicle allocation service providing device according to the aspect (1), a medium reader reading information for settlement from a medium provided by a user may be mounted on the plurality of automated driving vehicles. The vehicle allocation service providing device may further include a charging determiner configured to determine to charge the user based on the information read by the medium reader.

(5) In the vehicle allocation service providing device according to the aspect (1), a license reader reading license information from a license provided by a user may be mounted on the plurality of automated driving vehicles. The vehicle allocation service providing device may further include a non-automated driving permitter configured to permit non-automated driving by the user based on the information read by the license reader.

(6) The vehicle allocation service providing device according to the aspect (1) may further include: a service issuer configured to issue a service for the main user; and a service sharer configured to share ID information regarding the service with the user different from the main user in accordance with an intention of the main user.

(7) In the vehicle allocation service providing device according to the aspect (1), a use request of a user different from the main user includes ID information issued by a service sharer configured to shares the ID information regarding a service for the main user with the user different from the main user in accordance with an intention of the main user. Based on information regarding the route, the service manager may allow the user different from the main user to occupy at least part of one vehicle among the plurality of automated driving vehicles in a state in which the main user does not use the vehicle.

(8) According to another aspect of the present invention, a vehicle allocation service providing method causes a computer to: acquire a use request of a main user; instruct an automated driving vehicle of a route in response to the acquired use request; set the route of the automated driving vehicle based on the use request and a use request of a user different from the main user; and allocate a plurality of automated driving vehicles as relays to the main user based on one of a joining plan for the main user and a user different from the main user to use the same vehicle on the route or a branching plan for the main user and the user different from the main user to ride separately into a plurality of vehicles on the route.

(9) According to still another aspect of the present invention, a program causes a computer to: acquire a use request of a main user; instruct an automated driving vehicle of a route in response to the acquired use request; set the route of the automated driving vehicle based on the use request and a use request of a user different from the main user; and allocate a plurality of automated driving vehicles as relays to the main user based on one of a joining plan for the main user and a user different from the main user to use the same vehicle on the route or a branching plan for the main user and the user different from the main user to ride separately into a plurality of vehicles on the route.

### Advantageous Effects of Invention

According to the aspects of (1) to (3) and (6) to (9) above, it is possible to plan a more efficient service schedule.

According to the aspect of (4) above, by determining to charge a user based on the information read by the medium reader, it is not necessary to perform a special settlement process. Therefore, convenience for the user is improved.

According to the aspect of (5) above, by permitting non-automated driving of the user based on the information read by the license reader, the user can enjoy driving.

### BRIEF DESCRIPTION OF DRAWINGS

FIG. 1 is a diagram showing a configuration of a ridesharing system 1 including a vehicle allocation service providing device 300.

FIG. 2 is a diagram showing a configuration of a vehicle 200.

FIG. 3 is a diagram showing a procedure of an automated driving process.

FIG. 4 is a diagram showing an example of content of boarding condition information 384.

FIG. 5 is a diagram showing an example of content of service schedule information 388.

FIG. 6 is a flowchart (part 1) showing an example of a flow of a process performed by the vehicle allocation service providing device 300.

FIG. 7 is a flowchart (part 2) showing the example of the flow of the process performed by the vehicle allocation service providing device 300.

FIG. 8 is a diagram showing an example of a scenario in which vehicles 200 are extracted.

FIG. 9 is a diagram showing an example of information in which users classified by destination are associated with the vehicles 200.

FIG. 10 is a diagram showing another example of content of a service schedule.

FIG. 11 is a sequence diagram showing a flow of a process performed when a user U gets into the vehicle 200.

FIG. 12 is a diagram showing content of settlement information 390.

FIG. 13 is a diagram showing an example of an aspect in a converging point.

FIG. 14 is a diagram showing another example of the aspect in the converging point.

FIG. 15 is a diagram showing a functional configuration of a vehicle allocation service providing device 300A according to a second embodiment.

FIG. 16 is a diagram showing an example of content of boarding condition information 384 according to the second embodiment.

FIG. 17 is a flowchart (part 1) showing an example of a flow of a process performed by the vehicle allocation service providing device 300A.

FIG. 18 is a diagram showing an example of an image IM including a service schedule displayed on a display of a terminal device 100.

FIG. 19 is a flowchart (part 2) showing an example of a flow of a process performed by the vehicle allocation service providing device 300A according to the second embodiment.

FIG. 20 is a diagram showing an example of information in which users classified by destination are associated with the vehicles 200.

FIG. 21 is a diagram showing an example of a scenario in which a user at a converging point heads for a joining destination.

FIG. 22 is a diagram showing an example of a functional configuration of a vehicle allocation service providing device 300B according to a third embodiment.

FIG. 23 is a sequence diagram showing an example of a flow of a process performed by the vehicle allocation service providing device 300B according to the third embodiment.

FIG. 24 is a diagram showing an example of an aspect in which a main route is corrected by the vehicle allocation service providing device 300B.

### DESCRIPTION OF EMBODIMENTS

Hereinafter, an embodiment of a vehicle allocation service providing device, a vehicle allocation service providing method, and a program according to the invention will be described with reference to the drawings. The vehicle allocation service providing device is a device that supports shared use (ridesharing) of one or more vehicles by a plurality of users. A vehicle used for ridesharing is, for example, an automated driving vehicle for which driving operations are basically not necessary. Hereinafter, an automated driving vehicle that is used for ridesharing will be described, but a non-automated driving vehicle may be used.

When a boarding request is acquired through communication from a terminal device of a user, the vehicle allocation service providing device searches for a vehicle that matches a boarding condition defined in the boarding request (an available vehicle). The communication may include both data communication and voice communication, that is, phoning.

### First Embodiment

### [Overall Configuration]

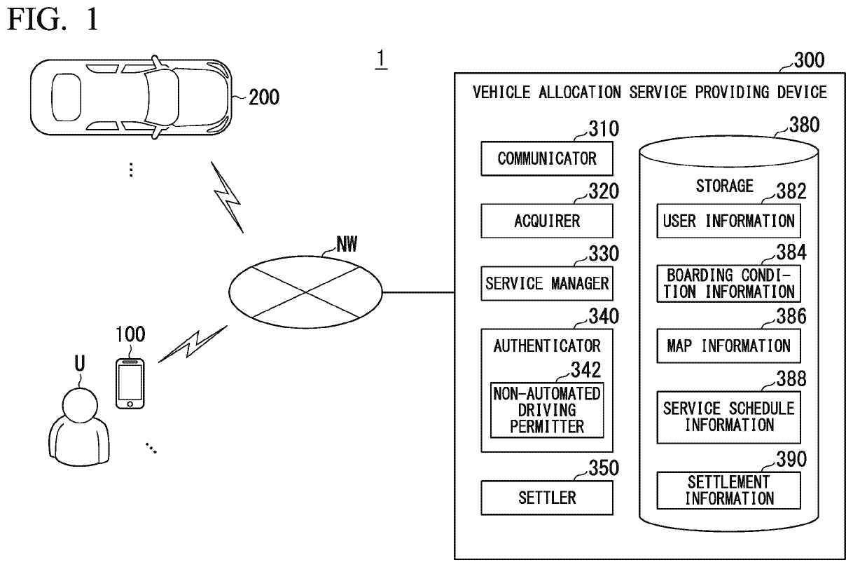

FIG. 1 is a diagram showing a configuration of a ridesharing system 1 including a vehicle allocation service providing device 300. The ridesharing system 1 includes one or more terminal devices 100 used by one or more users U, one or more vehicles 200, and the vehicle allocation service providing device 300. These constituent elements can communicate with one another via a network NW. The network NW includes the Internet, a wide area network (WAN), a local area network (LAN), a public communication line, a provider device, a dedicated line, and a wireless base station. The “use by a user U” may include temporary use of a user U using a terminal device which can be used by unspecified many people, such as a terminal device in an Internet cafe.

### [Terminal Device]

The terminal device 100 is, for example, a smartphone, a tablet terminal, or a personal computer. The terminal device 100 activates an application program, a browser, or the like for using the ridesharing system to support a service to be described below. In the following description, it is assumed that the terminal device 100 is a smartphone and an application program (ridesharing application) is activated. The ridesharing application communicates with the vehicle allocation service providing device 300 in response to an operation by the user U, transmits a request of the user U to the vehicle allocation service providing device 300, or performs push notification based on information received from the vehicle allocation service providing device 300.

### [Vehicle]

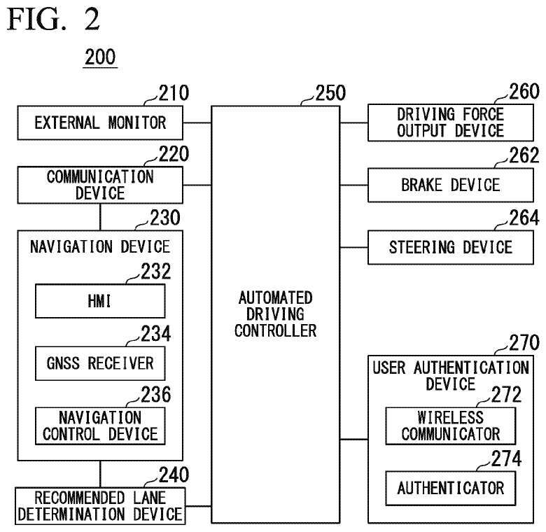

The vehicle 200 is, for example, a vehicle that has greater than or equal to four wheels and which a plurality of users U are able to board, but may be another vehicle such as a motorbike. FIG. 2 is a diagram showing a configuration of the vehicle 200. The vehicle 200 includes, for example, an external monitor 210, a communication device 220, a navigation device 230, a recommended lane determination device 240, an automated driving controller 250, a driving force output device 260, a brake device 262, and a steering device 264.

The external monitor 210 includes, for example, a camera or a radar, a light detection and ranging (LIDAR) finder and an object recognition device or the like that performs a sensor fusion process based on an output of the camera, the radar, or LIDAR finder. The external monitor 210 estimates kinds of objects (in particular, vehicles, pedestrians, and bicycles) around the vehicle 200 and outputs an estimation result to the automated driving controller 250 along with information regarding positions or speeds of the objects.

The communication device 220 is, for example, a wireless communication module that is connected to the network NW or directly communicates with another vehicle or a terminal device or the like of a pedestrian. The communication device 220 performs wireless communication based on Wi-Fi, dedicated short range communications (DSRC), Bluetooth (registered trademark), or another communication standard. The plurality of communication devices 220 may be prepared in accordance with purposes.

The navigation device 230 includes, for example, a human machine interface (HMI) 232, a global navigation satellite system (GNSS) receiver 234, and a navigation control device 236. The HMI 232 includes, for example, a touch panel display device, a speaker, and a microphone. The GNSS receiver 234 positions an own position (the position of the vehicle 200) based on radio waves arriving from GNSS satellites (for example, GPS satellites). The navigation control device 236 includes, for example, a central processing unit (CPU) and various storage devices and performs overall control of the navigation device 230. A storage device stores map information (a navigation map). The navigation map is a map in which roads are indicated using nodes and links. The navigation control device 236 determines a route from the position of the vehicle 200 positioned by the GNSS receiver 234 to a destination designated using the HMI 232 with reference to the navigation map. The navigation control device 236 may transmit the destination and the position of the vehicle 200 to a navigation server (not shown) using the communication device 220 and acquire a route returned by the navigation server. In the case of the embodiment, the route to the destination is designated by the vehicle allocation service providing device 300 in some cases. The route may include information regarding a stopping location and a target time of arrival to allow a user to get into or get out of the vehicle. The navigation control device 236 outputs the information regarding a route determined in accordance with any of the foregoing methods to the recommended lane determination device 240.

The recommended lane determination device 240 includes, for example, a map positioning unit (MPU) and various storage devices. A storage device stores highly accurate map information that is more detailed than that of the navigation map. The highly accurate map information includes, for example, information such as road widths, gradients, curvatures of respective lanes, and traffic signal positions. The recommended lane determination device 240 determines a preferred recommended lane to travel along a route input from the navigation device 230 and outputs the recommended lane to the automated driving controller 250.

The automated driving controller 250 includes one or more processors such as a

CPU or a micro processing unit (MPU) and various storage devices. The automated driving controller 250 causes the vehicle 200 to automatically drive so that the vehicle 200 avoids contact with objects of which positions or speeds are input from the external monitor 210 on the principle that the vehicle 200 travels along a recommended lane determined by the recommended lane determination device 240. The automated driving controller 250 performs, for example, various events in sequence. Examples of the events include a constant speed traveling event for traveling at a constant speed in the same travel lane, a following traveling event for following a front traveling vehicle (an event for causing the own vehicle to travel while maintaining an inter-vehicle distance to a front traveling vehicle as a set distance), a lane changing event, a merge event, a branching event, an emergency stopping event, a toll gate event for passing through a toll gate, and a handover event for ending automated driving and switching to non-automated driving. An action for avoidance is planned based on a surrounding situation (presence of a surrounding vehicle or pedestrian, contraction of a lane due to road construction, or the like) of the vehicle 200 while such an event is being performed in some cases.

The automated driving controller 250 generates a target trajectory along which the vehicle 200 travels in future. The target trajectory includes, for example, speed components. For example, the target trajectory is expressed by arranging locations (trajectory points) at which the own vehicle 200 will arrive in sequence. The trajectory point is a location at which the own vehicle 200 will arrive for each predetermined traveling distance. Apart from the trajectory points, target acceleration and a target speed are generated as parts of the target trajectory for each of predetermined sampling times (for example, about every several tenths of a second [sec]). The trajectory point may be a position at which the own vehicle 200 will arrive at the sampling time for each predetermined sampling time. In this case, information regarding the target acceleration or the target speed is expressed at an interval between the trajectory points.

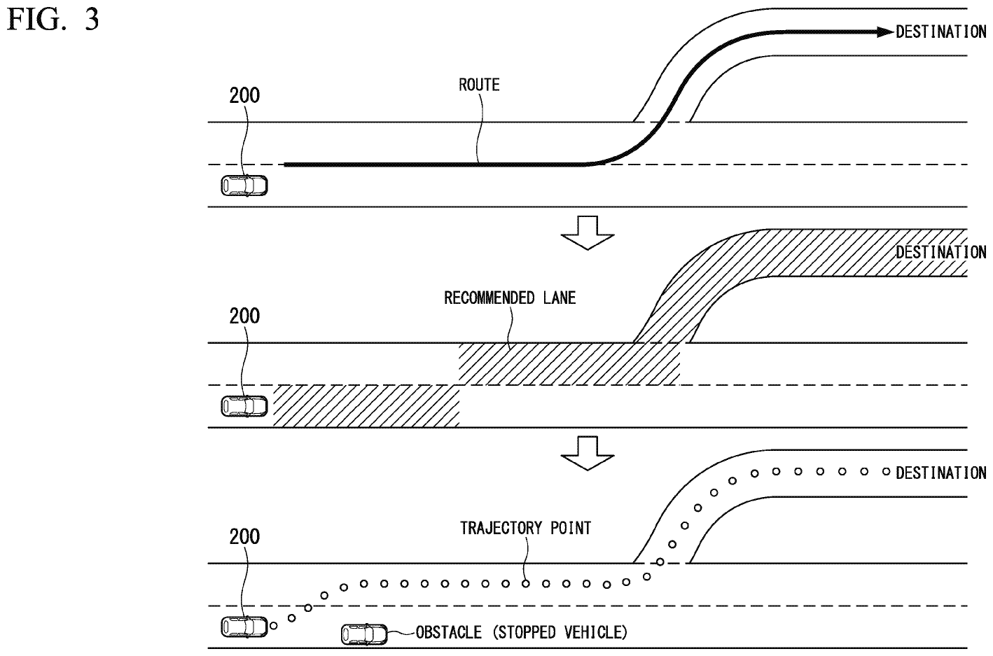

FIG. 3 is a diagram showing a procedure of an automated driving process. First, as shown in the upper drawing, the navigation device 230 determines a route. This route is, for example, a rough route in which lanes are not distinguished. Subsequently, as shown in the middle drawing, the recommended lane determination device 240 determines a recommended lane in which the vehicle easily travels along a route. As shown in the lower drawing, the automated driving controller 250 generates trajectory points for traveling along the recommended lane if possible, for example, while avoiding obstacles and controls some or all of the driving force output device 260, the brake device 262, and the steering device 264 such that the vehicle travels along the trajectory points (and a subordinate speed profile). The role sharing is merely exemplary and, for example, the automated driving controller 250 may perform processes unitarily.

The driving force output device 260 outputs a travel driving force (torque) for causing the vehicle to travel to a driving wheel. The driving force output device 260 includes, for example, a combination of an internal combustion engine, an electric motor and a transmission, and a power ECU controlling these units. The power ECU controls the foregoing configuration in accordance with information input from the automated driving controller 250 or information input from a driving operator (not shown).

The brake device 262 includes, for example, a brake caliper, a cylinder that transmits a hydraulic pressure to the brake caliper, an electronic motor that generates a hydraulic pressure to the cylinder, and a brake ECU. The brake ECU controls the electric motor in accordance with information input from the automated driving controller 250 or information input from the driving operator such that a brake torque in accordance with a brake operation is output to each wheel. The brake device 262 may include a mechanism that transmits a hydraulic pressure generated in response to an operation of the brake pedal included in the driving operator to the cylinder via a master cylinder as a backup. The brake device 262 is not limited to the above-described configuration and may be an electronic control type hydraulic brake device that controls an actuator in accordance with information input from the automated driving controller 250 such that a hydraulic pressure of the master cylinder is transmitted to the cylinder.

The steering device 264 includes, for example, a steering ECU and an electric motor. For example, the electric motor may change the direction of the steered wheels by applying a force to a rack and pinion mechanism. The steering ECU drives the electric motor to change the direction of the steering wheel in accordance with information input from the automated driving controller 250 or information input from the driving operator.

A user authentication device 270 includes a wireless communicator 272 and an authenticator 274. The wireless communicator 272 acquires information stored in an IC chip or a storage of the terminal device 100 by communicating with the IC chip included in a medium held up to a predetermined position by a user or the terminal device 100. The medium is, for example, a license, an IC card, or the like. The stored information is information indicating a user ID, a charged amount of electronic money, or permission of boarding in a preset section, for example, when the medium is an IC card, and is information (license information) indicating the name of a user, a licensed expiration date, a license number, or the like when the medium is a license. The user ID is an example of information for settlement. The user authentication device 270 is an example of a “medium reader” or a “ non-automated driving permitter.”

The authenticator 274 transmits information acquired by the wireless communicator 272 to the vehicle allocation service providing device 300 to request the vehicle allocation service providing device 300 to authenticate the acquired information. The authenticator 274 receives an authentication result of the request from the vehicle allocation service providing device 300 and determines whether to permit a user to get into a vehicle based on the received authentication result. Then, the authenticator 274 displays information based on whether to permit the user to get into the vehicle on a display or the like of the vehicle 200.

The user authentication device 270 may include a reader in addition to (or instead of) the wireless communicator 272. The reader reads code information printed on a medium or code information drawn in an image displayed on a display of the terminal device 100. The code information is provided to a user when the user reserves allocate or after settlement of the allocation is completed. The code information is, for example, a barcode or a QR (registered trademark) code. For example, information such as a user ID, a destination of an occupant, a one-time key is encoded in the code information. The authenticator 274 reads the information encoded in the code information held up to the reader of the own device, decodes the read information, acquires electronic information. Then, the authenticator 274 transmits the acquired information to the vehicle allocation service providing device 300 to make a request for authentication.

The vehicle 200 may acquire biological information of a user and transmit the acquired biological information to the vehicle allocation service providing device 300 to make a request for authentication. In this case, the vehicle allocation service providing device 300 permits the user to get into a vehicle when biological information of the user stored in advance in the storage 380 matches the acquired biological information. The biological information is, for example, a characteristic amount obtained from a face image, a fingerprint acquired by a fingerprint sensor, a voiceprint obtained by a microphone, an iris pattern, or the like. In this case, the vehicle 200 includes a camera that images the face of the user, a fingerprint sensor, a microphone, or a detector that detects an iris pattern.

### [Vehicle Allocation Service Providing Device]

Referring back to FIG. 1, the vehicle allocation service providing device 300 includes, for example, a communicator 310, an acquirer 320, a service manager 330, an authenticator 340, a settler (charging determiner) 350, and a storage 380.

The communicator 310 is, for example, a network card connected to the network NW. The storage 380 is realized by a hard disk drive (HDD), a flash memory, a random access memory (RAM), a read-only memory (ROM), or the like. The communicator 310 communicates with the terminal device 100 or the vehicle 200 via the network NW.

The acquirer 320, the service manager 330, the authenticator 340, and the settler 350 are realized, for example, when a processor such as a CPU executes a program (software) stored in the storage 380. Some or all of the functional units may be realized by hardware such as a large scale integration (LSI), an application specific integrated circuit (ASIC), or a field-programmable gate array (FPGA), or a graphics processing unit (GPU) or may be realized by software and hardware in cooperation. The program may be stored in advance in a storage device such as a hard disk drive (HDD) or a flash memory or may be stored in detachable storage medium such as a DVD or a CD-ROM so that the storage medium is installed in a drive device and is installed in the storage device.

The acquirer 320 acquires a boarding request output from the terminal device 100 of the user via the communicator 310 and the network NW and registers a boarding condition included in the boarding request as boarding condition information 384 in the storage 380.

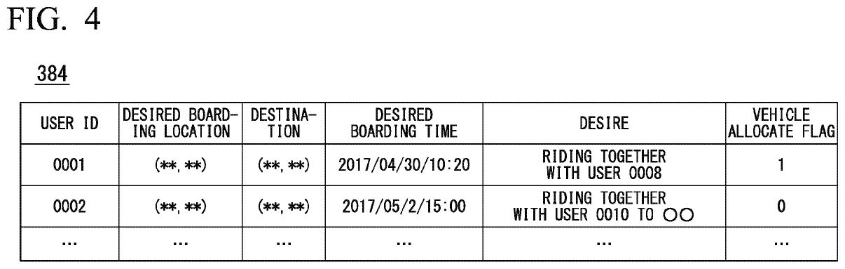

FIG. 4 is a diagram showing an example of content of the boarding condition information 384. As shown, the boarding condition information 384 is information in which a desired boarding location, a destination, a desired boarding time, desire information indicating a desire of the user, a vehicle allocate flag indicating whether allocate is determined (for example, 1 indicates that allocate is determined and 0 indicates that allocate is not determined), and the like are associated with a user ID which is identification information of a user registered in advance. The desired boarding location, the destination, and the desired boarding time are examples of a “movement plan.” The desire information is, for example, information regarding a kind of vehicle 200 (a sedan, a sports car, or a car for six people) into which a user desires to get, information regarding a user desired to get into a vehicle together, information regarding a ridesharing section, the number of people who want to get into the vehicle, or the like. Content of information other than the vehicle allocate flag is determined by allowing the ridesharing application of the terminal device 100 to receive an input of a user and is transmitted as a boarding request to the allocation service supply device 300. Hereinafter, a series of information associated with one user ID in the boarding condition information 384 is referred to as a record in some cases.

The service manager 330 searches for the available vehicle 200 with reference to the boarding condition information 384, the map information 386, and service schedule information 388. The map information 386 includes facility information indicating an overview of various facilities in addition to information regarding nodes or links (a navigation map or a highly accurate map of the vehicle 200 may include such information).

For example, the service manager 330 roughly groups records in which periods of time and travel sections from a desired boarding location to a destination are close among records included in the boarding condition information 384, extracts one or more records associated with one or more users who can be transported in one vehicle 200, and registers the records as part of the service schedule information 388 in the storage 380.

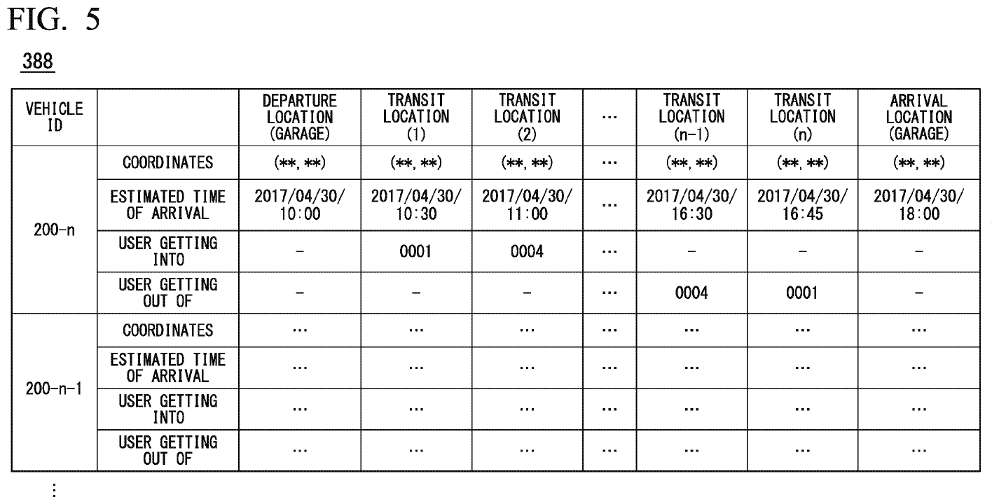

FIG. 5 is a diagram showing an example of content of the service schedule information 388. As shown, the service schedule information 388 is information in which coordinates of a departure location, a transit location, and an arrival location, an estimated time of arrival of the vehicle 200, a user ID of a user getting into at each transit location, and a user ID of a user getting out of the vehicle 200 are associated with a vehicle ID which is identification information of the vehicle 200 managed by the vehicle allocation service providing device 300. The departure location or the arrival location is normally a garage or the like. Information regarding a “vacant vehicle” of which a service schedule has not yet been determined is also registered in the service schedule information 388. In this case, for a vacant vehicle, only coordinates of a departure location is registered. The service manager 330 may collect boarding requests from a plurality of users and determine a service schedule of one vehicle 200, as described above, or may search for a service schedule determined in advance and change the service schedule so that boarding requests of other users are included. That is, when the service manager 330 searches for the available vehicle 200, the service manager 330 may search for the vehicle 200 of which the service schedule is not yet determined or may search for a service schedule which can include a boarding request of a user among service schedules of the already determined vehicle 200. At a predetermined timing, the service manager 330 transmits information regarding a route (transit location) based on the service schedule information 388 and an estimated passage time to the vehicle 200.

When a boarding request acquired by the acquirer 320 is realized, the service manager 330 drafts plans that include a joining plan for allowing a user having gotten into another vehicle to join and get into one vehicle or a branching plan for allowing a plurality of users having gotten into one vehicle to get and branch into different vehicles in an allocate schedule of an automated driving vehicle realized by instructing a plurality of automated driving vehicles of a route.

The authenticator 340 performs an authentication process (the details thereof will be described below) based on information transmitted from the vehicle 200 and information stored in the storage 380. The authenticator 340 includes a non-automated driving permitter 342. The non-automated driving permitter 342 permits a user to perform non-automated driving based on the information read by the user authentication device 270. The settler 350 performs a settlement process with reference to information (settlement information 390 to be described below) stored in the storage 380. The details of processes of the authenticator 340 and the settler 350 will be described below.

### [Process Flow and Scenario Example]

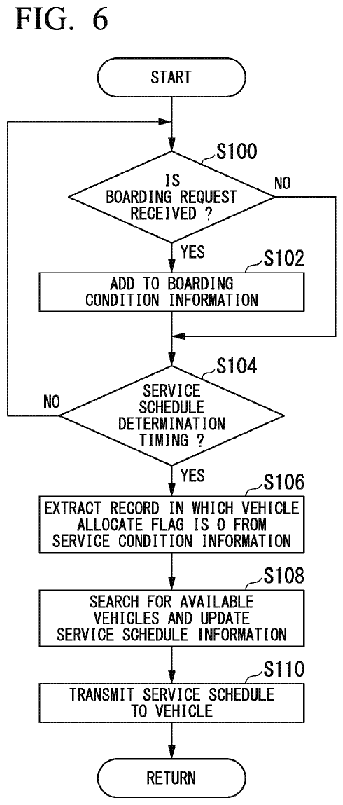

FIG. 6 is a flowchart (part 1) showing an example of a flow of a process performed by the vehicle allocation service providing device 300. First, the vehicle allocation service providing device 300 determines whether a boarding request is received from the terminal device 100 (step S100). When the boarding request is received from the terminal device 100, the vehicle allocation service providing device 300 adds a boarding condition included in the boarding request to the boarding condition information 384 (step S102).

Subsequently, the vehicle allocation service providing device 300 determines whether a service schedule determination timing arrives (step S104). When the service schedule determination timing does not come, the process returns to step S100. Any service schedule determination timing can be determined. For example, the service schedule determination timing arrives at intervals of a predetermined time (for example, about 10 minutes) during business hours of the ridesharing system 1.

When the service schedule determination timing arrives, the vehicle allocation service providing device 300 extracts a record in which the vehicle allocate flag is 0 from the boarding condition information 384 (step S106). Subsequently, the vehicle allocation service providing device 300 searches for the available vehicles 200 and updates the service schedule information 388 based on a search result (step S108). At this time, the vehicle allocation service providing device 300 allocates the vehicle 200 in accordance with a movement distance of the user or the number of boarding people among the available vehicles 200. For example, when the movement distance of the user is long at the time of the allocation, a vehicle in which the user will not feel tired despite a long-time boarding of the user (for example, a vehicle of which there is little shaking during the time of traveling) is selected. When the user getting into the vehicle is alone in a section to the destination in the service schedule, the vehicle 200 into which one person can get or two persons can get is preferentially selected. When the boarding request of one person includes a request indicating that the number of people getting into the vehicle is five or six, the vehicle 200 into which six or more persons can get is selected.

Subsequently, the vehicle allocation service providing device 300 transmits the service schedule added or updated in the present process to the vehicle 200 (step S110). Then, the process of one routine of the flowchart ends. In this way, the vehicle allocation service providing device 300 generates the above-described schedule of FIG. 5.

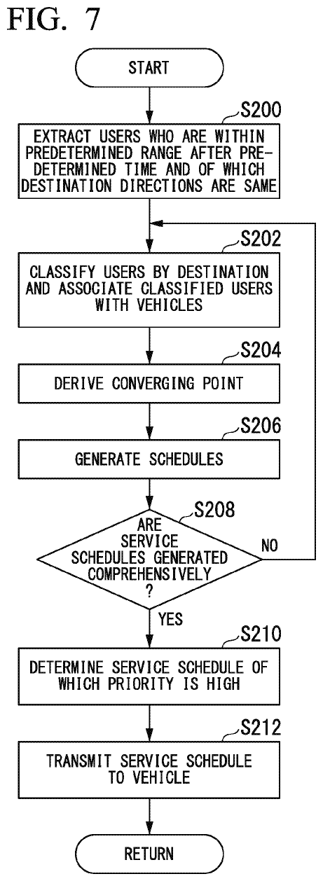

FIG. 7 is a flowchart (part 2) showing the example of the flow of the process performed by the vehicle allocation service providing device 300. The process is a process performed separately from the process of the above-described flowchart of FIG. 6. For example, the process of the flowchart of FIG. 7 is a process performed at intervals of a predetermined time (for example, about 10 minutes).

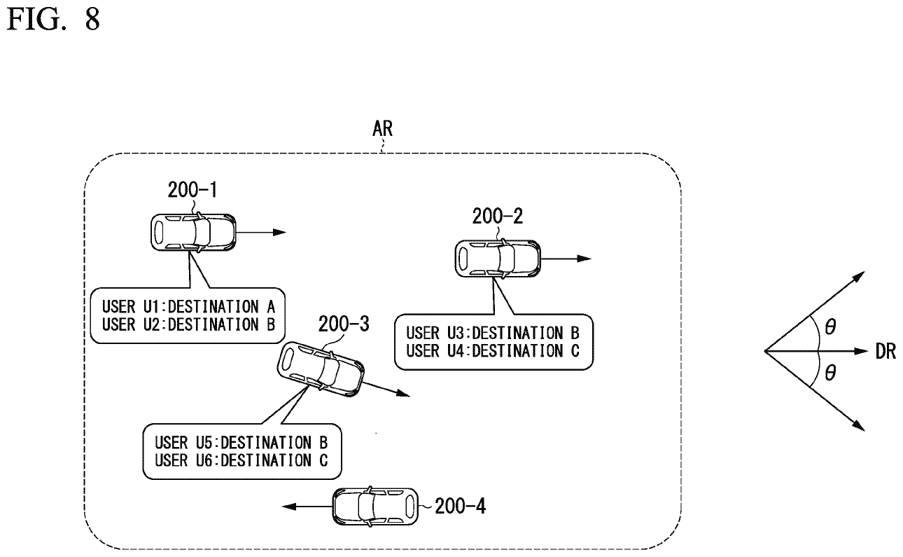

First, the vehicle allocation service providing device 300 extracts the vehicles 200 which are within a predetermined range after a predetermined time and of which preceding directions are the same (step S200). FIG. 8 is a diagram showing an example of a scenario in which vehicles 200 are extracted. The vehicle allocation service providing device 300 recognizes preceding directions of vehicles 200-1 to 200-4 which are in a predetermined range AR after a predetermined time. The preceding directions are directions extended from predetermined standard positions to the destination directions of the vehicles 200. The preceding directions which are the same include preceding directions within the range of a positive and negative predetermined angle θ set using a preset direction DR as a standard. In the shown example, the vehicles 200-1 to 200-3 excluding the vehicle 200-4 are extracted as vehicles of which the preceding directions are the same.

The users U1 and U2 get into the vehicle 200-1, the users U3 and U4 get into the vehicle 200-2, and the users U5 and U6 get into the vehicle 200-3. It is assumed that the destination of the user U1 is “A,” the destination of the users U2, U3, and U5 is “B,” and the destination of the users U4 and U6 is “C.”

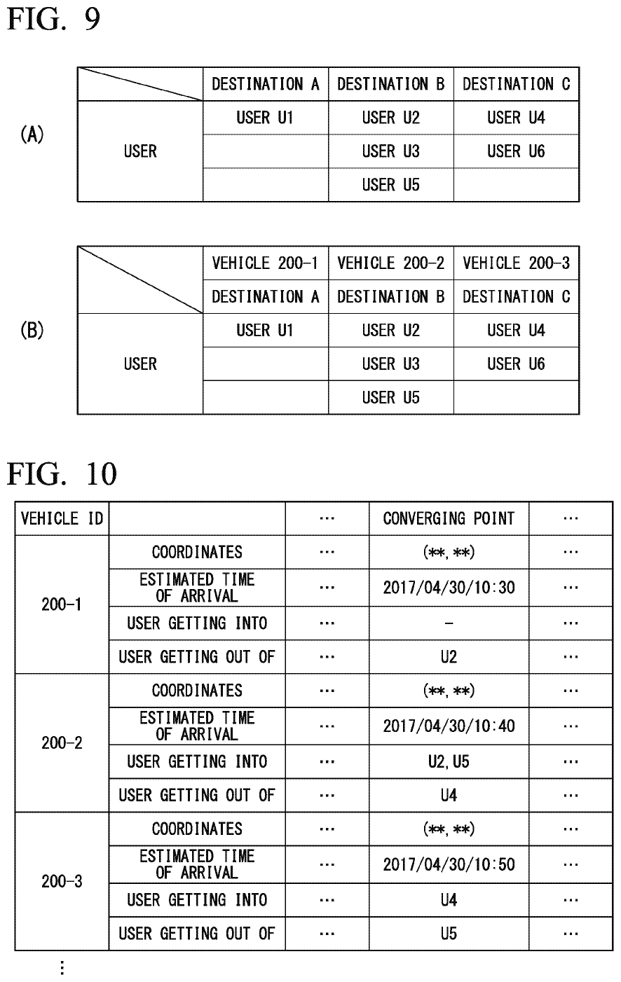

Subsequently, the vehicle allocation service providing device 300 classifies the users of the vehicles 200 extracted in step S200 by destination of the users and associates the classified users with the vehicles 200 (step S202). FIG. 9 is a diagram showing an example of information in which users classified by destination are associated with the vehicles 200. As shown in (A) of FIG. 9, the users are classified by destination and the vehicles 200 are associated with the classified users, as shown in (B) of FIG. 9. For example, as shown in (B) of FIG. 9, the vehicle 200-1 is associated with the user U1 heading for the destination A, the vehicle 200-2 is associated with the users U2, U3, and U5 heading for the destination B, and the vehicle 200-3 is associated with the users U4 and U6 heading for the destination C.

Subsequently, the vehicle allocation service providing device 300 derives a converging point based on the positions of the vehicles 200 extracted in step S200 (step S204). For example, the converging point is a position at which the joining vehicles 200 can assemble as fast as possible, a position at which a sum traveling distance of the joining vehicles 200 is the shortest, a preset position, or the like.

Subsequently, the vehicle allocation service providing device 300 generates a service schedule based on process results of the foregoing steps S202 and S204 (step S206). Subsequently, the vehicle allocation service providing device 300 determines whether the service schedules are generated comprehensively (step S208). Generating the service schedules comprehensively is generating the service schedules by performing the process of classifying the users by destination comprehensively or performing the process of associating the classified users with the vehicles 200 comprehensively. In the examples of FIGS. 8 and 9 described above, it is assumed that there are users heading for the destinations A to C and there is the number of vehicles 200 which is the same as the number of destinations, as described above. For example, when there is a user heading for a destination D in addition to the foregoing users, a service schedule in a case in which the user heading for the destination D is included in each group of the users heading for the destinations A to C is generated.

When the service schedules are not generated comprehensively, the process returns to step S202. When the service schedules are generated comprehensively, the vehicle allocation service providing device 300 determines a service schedule with the highest priority among the plurality of service schedules generated in the foregoing process (step S210). The fact that the priority is the highest is, for example, that an index is the highest when the following indexes are summed. The indexes are, for example, indexes associated with waiting times of the users, indexes associated with travel distances of the vehicles 200, indexes associated with operation rates of the vehicles 200 to be managed, indexes associated with desires of the users, and the like. For example, as a waiting time of a user becomes shorter, a traveling distance of the vehicle 200 becomes shorter, an operation rate of the vehicle 200 to be managed becomes higher, or a degree of matching to a desire of a user becomes higher, a higher index is derived. An index indicating the degree of matching to a desire of a user is considered to be most important. For example, a service schedule which a desire of the user does not match may be excluded.

Subsequently, the vehicle allocation service providing device 300 transmits the service schedule (see FIG. 10) determined in step S210 to the vehicles 200 (step S212). The service schedule shown in FIG. 10 is set such that the user U1 gets into the vehicle 200-1, the users U2, U3, and U5 get into the vehicle 200-2, and the users U4 and U6 get into the vehicle 200-3 at the converging point to head for respective destinations. Then, the process of one routine of the flowchart ends.

### [Process When Users Get Into Vehicles]

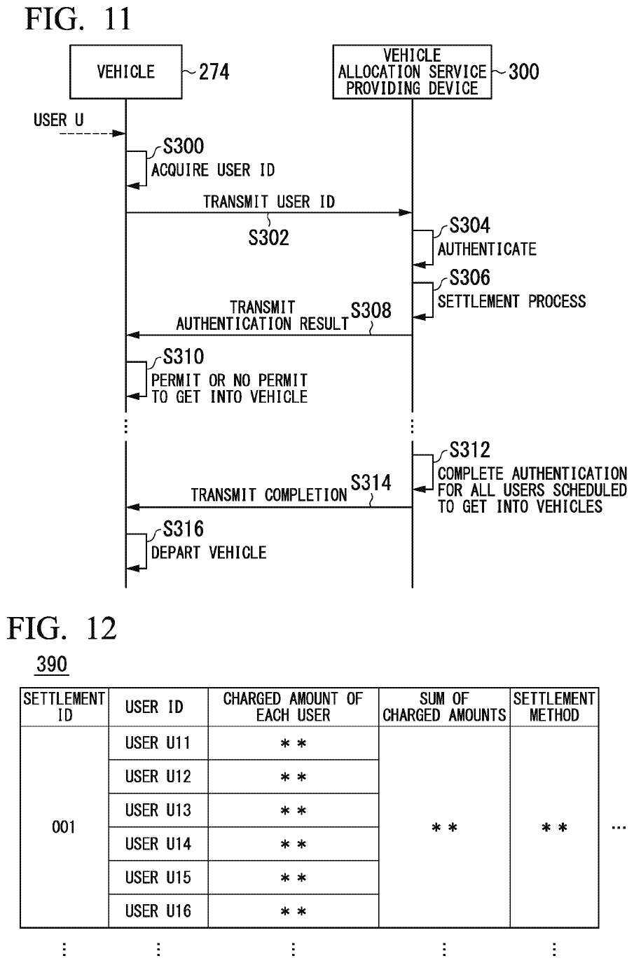

FIG. 11 is a sequence diagram showing a flow of a process performed when a user U gets into the vehicle 200. The process is a process when the user U gets into the vehicle 200 at a converging point. For example, when the user U holds up an IC card to a predetermined position on the vehicle 200, the vehicle 200 communicates with the IC card and acquires a user ID (step S300). Subsequently, the vehicle 200 transmits the acquired user ID and the vehicle ID to the vehicle allocation service providing device 300 (step S302).

The vehicle allocation service providing device 300 receives the user ID and the vehicle ID from the vehicle 200 and performs an authentication process of determining whether the received user ID is included in the service schedule associated with the vehicle ID (step S304).

Subsequently, the vehicle allocation service providing device 300 performs a settlement process on a settlement ID associated with the user ID with reference to the settlement information 390 (step S306). FIG. 12 is a diagram showing content of the settlement information 390. The settlement information 390 is information in which the user ID, a charged amount of each user ID, a sum of charged amounts with regard to the settlement ID, a settlement method (account withdrawing, credit card settlement), and the like are associated with the settlement ID. The settlement information 390 includes information (an account number or a credit card number) regarding a settlement method. For example, the settler 350 performs settlement by specifying a settlement ID associated with a user ID in the settlement information 390 and charging the specified settlement ID.

For example, a fee to be charged may be set for each boarding section of the vehicle 200 or may be a fixed fee. The fee to be charged may be determined for each use time or each use distance. Further, when one or both of the use time and the use distance are within predetermined ranges, the fee to be charged may be a fixed fee. For example, when the user associated with one settlement ID makes a request for allocating the plurality of vehicles 200 on the same day or for the same period of time, the amount of money may be charged based on a preset free structure. For example, when the plurality of vehicles 200 are allocated for the same period of time, a use fee may be discounted.

When the user gets into the vehicle 200, subsequently operates the HMI 232 or the like, and uses an infotainment option (viewing and hearing of contents or the like), this use may be charged.

FIG. 11 is referred to back for description. Subsequently, the vehicle allocation service providing device 300 transmits a result of the authentication process to the vehicle 200 (step S308). For example, when the received user ID is included in the service schedule associated with the vehicle ID, the vehicle allocation service providing device 300 transmits an optimistic authentication result to the vehicle 200. When the received user ID is not included in the service schedule associated with the vehicle ID, the vehicle allocation service providing device 300 transmits a pessimistic authentication result to the vehicle 200. Subsequently, the vehicle 200 permits or does not permit the user to get into the vehicle based on the result of the authentication process (step S310).

Subsequently, the vehicle allocation service providing device 300 determines whether the authentication process for all the users scheduled to get into the vehicles at the converging point and included in the service schedule is completed (step S312). When the authentication process for all the users is completed, the vehicle allocation service providing device 300 transmits information indicating the completion of the foregoing authentication process to the vehicle 200 (step S314). Subsequently, when the vehicle 200 receives the information indicating the completion of the authentication process from the vehicle allocation service providing device 300, the vehicle 200 starts traveling toward the destination (step S316).

In the foregoing example, when the users get into the vehicles 200, the settlement is performed, as described above. However, the settlement may be performed when the users get out of the vehicles 200. In this case, for example, the users hold up the IC cards to predetermined positions when the users get out of the vehicles.

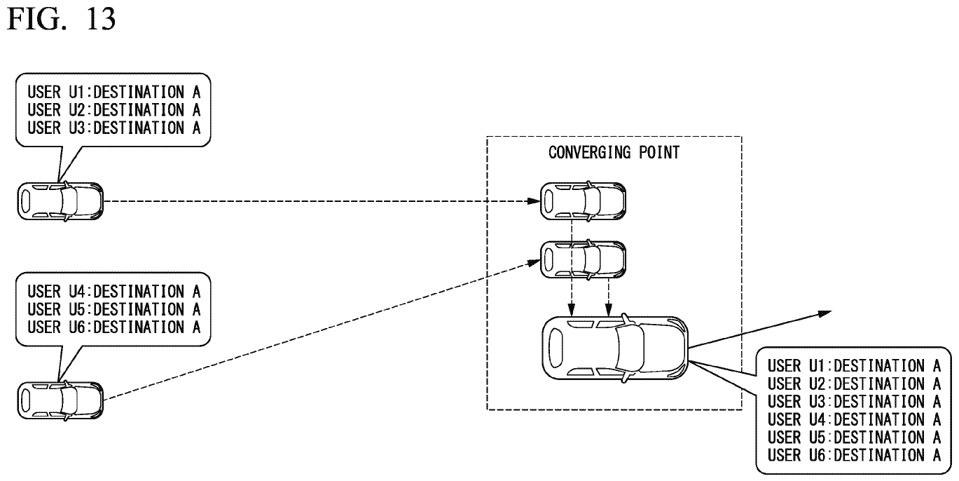

In the foregoing example, the predetermined user transfers to another vehicle 200 at a converging point to head for the destination, as described above. As shown in FIG. 13, however, all the users may transfer to one vehicle 200 to head for the destination. For example, it is assumed that the users U1 to U6 are set as one group and the destinations are the same, but the vehicle 200 into which the users U1 to U6 can get (a vehicle for six persons) is not available in the service schedule from the predetermined position to the converging point. In this case, through the foregoing process, the users U1 to U6 can head for the destination using one vehicle 200 by allocating the vehicle 200 into which six persons can get to the converging point.

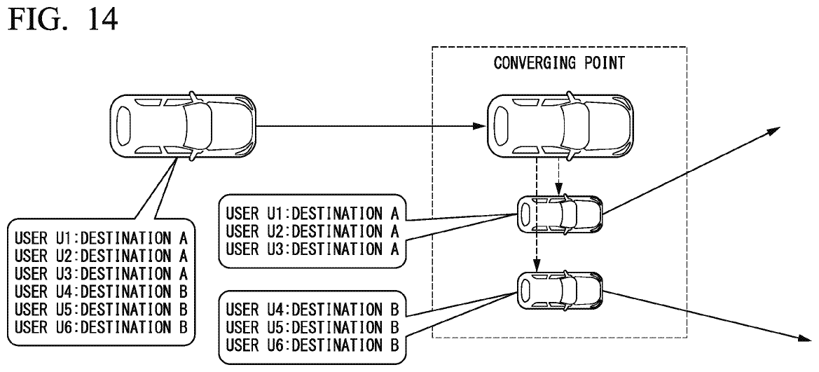

As shown in FIG. 14, when the users U1 to U6 included in one group go to a tourist site, it is assumed that the users get into one vehicle 200 to a base location of the tour site and subsequently the users U1 to U3 head for the destination A and the users U4 to U6 head for the destination B. In this case, at the converging point, the users U1 to U3 and the users U4 to U6 can get into separate vehicles 200 allocated through the foregoing process to head for the respective destinations.

At the converging point, the vehicle 200 which becomes unnecessary due to transfer of the users to another vehicle 200 is instructed to travel to a predetermined location (a deadheading location) through automated driving by the vehicle allocation service providing device 300. Thus, the vehicle 200 returns to a predetermined location and waits until other users U are allowed to get into the vehicle 200 or a pick-up instruction is given from the vehicle allocation service providing device 300.

A display included in the HMI 232 may display, for example, positional information of the converging point, information (a kind, shape, and color of the information) regarding the joining vehicle 200, information (an attribute such as sex) regarding users getting into the joining vehicle 200, positional information of the joining vehicle 200, information regarding the vehicle 200 to which the users transfer at the converging point, information regarding the users getting into the vehicle 200 to which the users transfer at the converging point, and the like. The foregoing information may be transmitted from the vehicle allocation service providing device 300 or may be transmitted from another vehicle 200.

The automated driving vehicle or the non-automated driving vehicle may be selectively used for ridesharing. For example, a user may include information indicating a desire to allocate an automated driving vehicle or a non-automated driving vehicle in a boarding request. In this case, the vehicle allocation service providing device 300 allocates a vehicle associated with a kind of vehicle 200 included in the boarding request to the user.

After the allocated vehicle 200 arrives at a location at which the user is picked up, the user may manually drive the vehicle 200 by himself or herself to head for a destination. For example, when the user operates the HMI 232 of the vehicle 200 and inputs information indicating a desire for non-automated driving in the case of non-automated driving, the HMI 232 requests the user to show a license. When the user holds up his or her license to the user authentication device 270, the wireless communicator 272 communicates with an IC chip included in a license, acquires information (a name, an expiration date of the license, or and the like) regarding the user stored in the IC chip, and transmits the acquired information to the vehicle allocation service providing device 300.

The non-automated driving permitter 342 of the vehicle allocation service providing device 300 determines validation of the license based on the acquired information regarding the user and the authenticator 340 determines whether the user showing his or her license matches the user transmitting the boarding request. When the non-automated driving permitter 342 determines that the license is valid and the authenticator 340 determines that the user showing the license matches the user transmitting the boarding request, information indicating that the user is permitted to perform non-automated driving is transmitted to the vehicle 200. Thus, the vehicle 200 permits the user to perform non-automated driving.

At this time, when the user is a predetermined user (for example, a user of a predetermined age or more), the non-automated driving permitter 342 transmits information indicating that the user is the predetermined user to the vehicle 200. When the user performing the non-automated driving is the predetermined user, the vehicle 200 may control a predetermined device on the vehicle side instead of control which is an operation performed by the user on the driving operator of the vehicle 200 and is control for the predetermined device in accordance with the operation. The predetermined device is the driving force output device 260, the brake device 262, or the steering device 264. More specifically, the foregoing control on the vehicle side is performed instead of the control in accordance with the operation of the driving operator at a timing at which the control is started by an operation by the user on the driving operator of the vehicle 200. The foregoing control may be performed when control deviating from a predetermined range is started by the control on the driving operator.

When a desire of a user without a reservation to use the allocated vehicle 200 is detected, the service manager 330 may allow the user without a reservation to get into the vehicle 200. The user without a reservation is a user who is not included in a service schedule of the allocated vehicle 200. For example, when a user ID is acquired from a medium held to the user without a reservation, the user authentication device 270 transmits the acquired user ID to the vehicle allocation service providing device 300. When the received user ID is the user ID of the user without a reservation and there is an unconditional or residue seat (when a user incorporated in the service schedule can get into the vehicle although the user without a reservation is allowed to get into the vehicle), the vehicle allocation service providing device 300 transmits, to the vehicle 200, information indicating that the user ID of the user without a reservation is incorporated into the service schedule and the user without a reservation is permitted to get into the vehicle. Thus, the user without a reservation can get into the vehicle 200 which is nearby without being reserved.

When the user without a reservation is allowed to get into the vehicle 200 and the user incorporated into the service schedule in advanced reservation may not get into that vehicle 200, the vehicle allocation service providing device 300 may allocate another vehicle 200 for the user who may not get into the vehicle 200. As a result, it is possible to improve convenience for a user who has not made a reservation without degrading convenience for a user who has made a reservation. The user may set non-permission of a user without a reservation by transmitting a desire indicating that a user without a reservation is not permitted to use the vehicle to the vehicle allocation service providing device 300 in advance.

According to the above-described first embodiment, the vehicle allocation service providing device 300 can plan a more efficient service schedule by drafting plans that include a joining plan for allowing a user having gotten into another vehicle 200 to join and get into one vehicle 200 or a branching plan for allowing a plurality of users having gotten into one vehicle 200 to get and branch into different vehicles 200 in an allocate schedule of an automated driving vehicle realized by instructing a plurality of automated driving vehicles of a route when the boarding request is realized.

### Second Embodiment

Hereinafter, a second embodiment will be described. In the second embodiment, users uses moving bodies (trains, buses, taxis, airplanes, ships, and the like) of other transportation systems in addition to the ridesharing vehicle 200. Hereinafter, differences from the first embodiment will be mainly described.

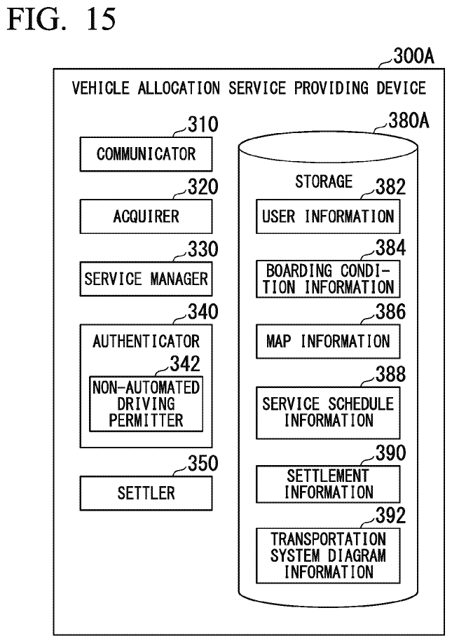

FIG. 15 is a diagram showing a functional configuration of a vehicle allocation service providing device 300A according to a second embodiment. The vehicle allocation service providing device 300A includes a storage 380A instead of the storage 380. The storage 380A further stores traffic system diagram information 392 in addition to the information stored in the storage 380. In the traffic system diagram information 392, a transport system diagram and a transport system running situation are stored. The information included in the traffic system diagram information 392 is information acquired from a server device of each transport system.

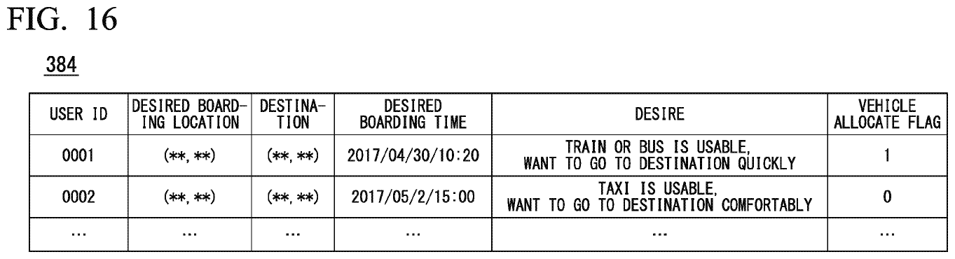

FIG. 16 is a diagram showing an example of content of the boarding condition information 384 according to the second embodiment. As shown, the boarding condition information 384 includes information indicating permission to use another transportation system or information indicating a viewpoint emphasizing heading for a destination as desire information indicating a desire of the user in addition to the ridesharing vehicle 200. For example, in the desire information, preference for permitting the user to use a train or a bus and arriving quickly at a destination, preference for arriving at a destination comfortably using a taxi or the ridesharing vehicle 200 without using a train or a bus, or the like is regulated.

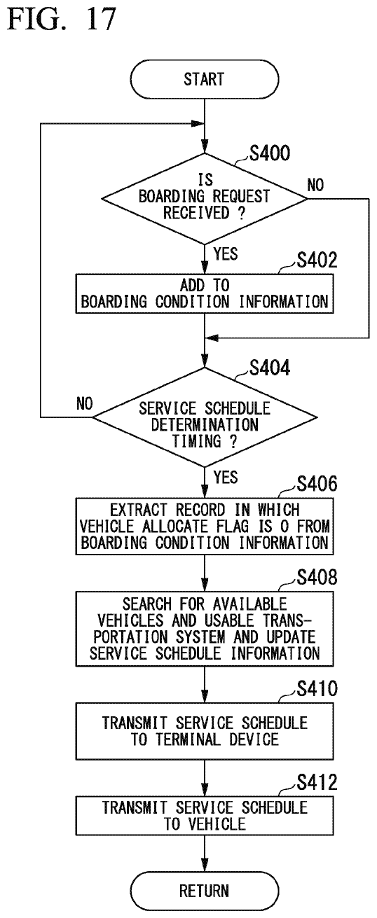

FIG. 17 is a flowchart (part 1) showing an example of a flow of a process performed by the vehicle allocation service providing device 300A. Since the processes of steps S400 to S406 of the flowchart of FIG. 17 are the same as the processes of steps S100 to S106 of the flowchart of FIG. 6, description thereof will be omitted.

After the process of step S406, the vehicle allocation service providing device 300 searches for transportation systems usable as the available vehicle 200 and updates the service schedule information 388 based on a search result and a desire of the user (step S408). Subsequently, the vehicle allocation service providing device 300 transmits the updated service schedule information associated with the user of a transmission destination to the terminal device 100 of the user (step S410). Subsequently, the vehicle allocation service providing device 300 transmits the updated service schedule information associated with the vehicle 200 of the transmission destination to the vehicle 200 (step S412). Then, the process of one routine of the flowchart ends.

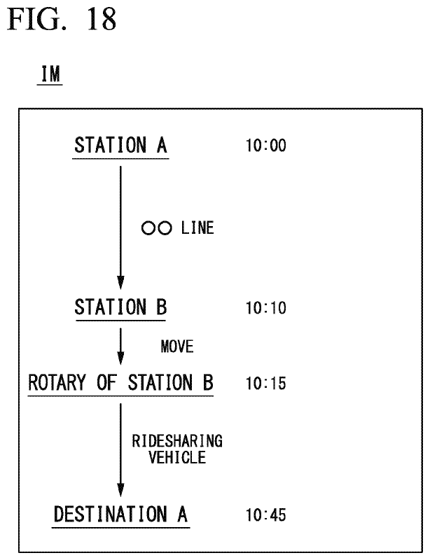

FIG. 18 is a diagram showing an example of an image IM including a service schedule displayed on a display of the terminal device 100. The image IM includes, for example, information indicating a schedule in which a user moves from a station A which is a departure position of the user to a station B by train, moves to a rotary of the station B after arriving at the station B, and gets into the ridesharing vehicle 200 at the rotary of the station B to head for the destination A.

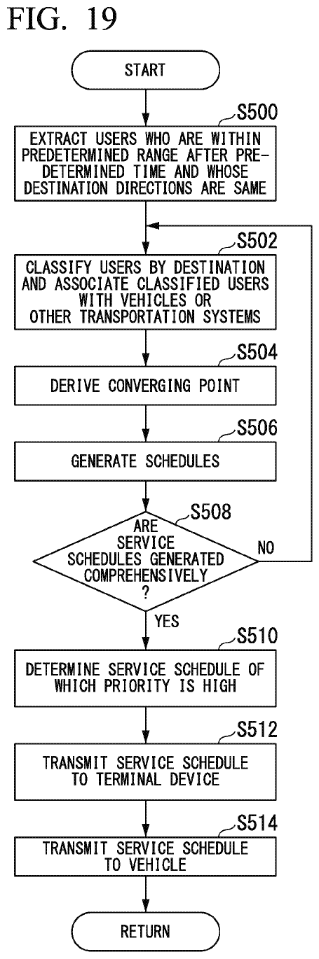

FIG. 19 is a flowchart (part 2) showing an example of a flow of a process performed by the vehicle allocation service providing device 300A according to the second embodiment. This process is a process performed separately from the above-described process of the flowchart of FIG. 17. For example, the process of the flowchart of FIG. 19 is a process performed at intervals of a predetermined time (for example, about 10 minutes).

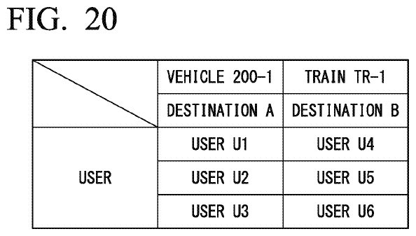

First, the vehicle allocation service providing device 300 extracts users who are within a predetermined range after a predetermined time and whose destination directions are the same (step S500). Subsequently, the vehicle allocation service providing device 300 classifies the users extracted in step S500 by destination of the users and associates the classified users with the vehicles 200 or other transportation systems (step S502). FIG. 20 is a diagram showing an example of information in which the users classified by destination are associated with the vehicles 200. For example, the users U1 to U6 are assumed to get into the vehicle 200-1. In this case, the users are classified into the users U1 to U3 and the users U4 to U6 by destination and the vehicles 200 or other transportation systems can be associated with the classified users. For example, as shown in FIG. 20, the vehicle 200-1 is associated with the users U1 to U3 heading for the destination A and a train TR-1 heading for the destination B is associated with the users U4 to U6 heading for the destination B.

Subsequently, the vehicle allocation service providing device 300 derives a converging point based on the positions of the vehicles 200 extracted in step S500 and a running situation of the train TR-1 (step S504). For example, the converging point is a station at which the vehicle 200-1 can arrive near a time at which the train TR arrives among stations at which the train TR-1 stops.

Subsequently, the vehicle allocation service providing device 300 generates a service schedule based on process results of the foregoing steps S502 and S504 (step S506). Subsequently, the vehicle allocation service providing device 300 determines whether the service schedules are generated comprehensively (step S508).

When the service schedules are not generated comprehensively, the process returns to step S502. When the service schedules are generated comprehensively, the vehicle allocation service providing device 300 determines a service schedule with the highest priority among the plurality of service schedules generated in the foregoing process (step S510).

Subsequently, the vehicle allocation service providing device 300 transmits the service schedules determined in step S508 to the terminal device 100 of the user (step S512). Subsequently, the vehicle allocation service providing device 300 transmits the service schedules determined in step S508 to the vehicles 200 (step S514). Then, the process of one routine of the flowchart ends.

For example, optional information of a schedule for movement of a user may be displayed on a display included in the HMI 232 or a display of the terminal device 100. The optional information is information regarding the vehicle 200 which can be used when the user arrives at a destination or a moving body of another transportation system. For example, the user can change the vehicle 200 or the transportation system to be used by selecting a desired movement route, the transportation system, and the like from the information displayed on the display. The foregoing information may be transmitted from the vehicle allocation service providing device 300 or may be transmitted from the terminal device 100 of another user.

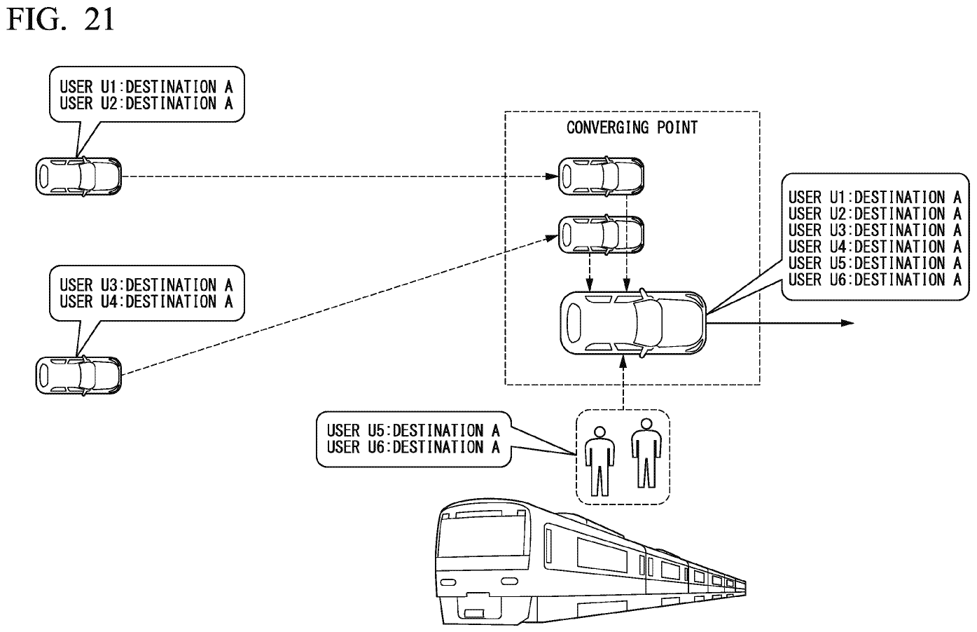

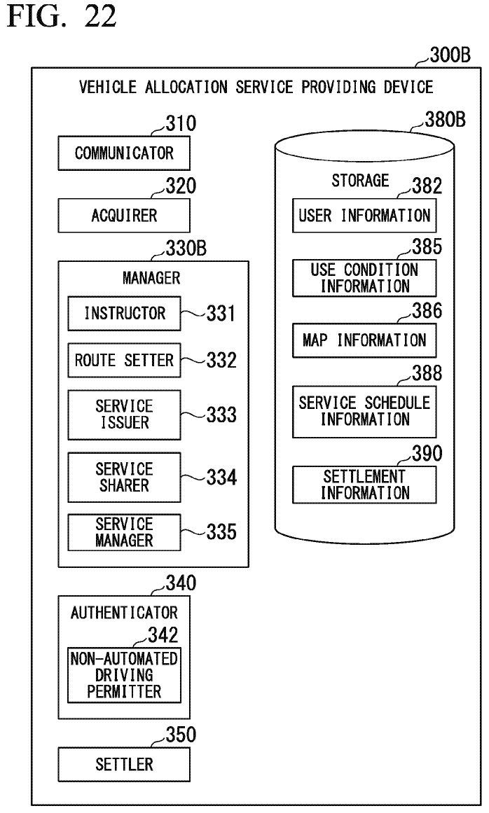

FIG. 21 is a diagram showing an example of a scenario in which a user at a converging point heads for a joining destination. For example, when departure locations of the users U are different, the users assemble and head for a destination, the vehicle allocation service providing device 300 sets a converging point at which the users U1 and U2 getting into the vehicle 200-1, the users U3 and U4 getting into the vehicle 200-2, and the users U5 and U6 getting into the train TR-1 join and allocates the vehicle 200-3 into which the users get at a set point. Thus, the users U1 to U6 can head for the destination using one vehicle 200.

According to the above-described second embodiment, the vehicle allocation service providing device 300 can obtain the advantageous effects of the first embodiment and plan a service schedule useful for the users by drafting plans that include a joining plan for allowing the users having gotten into transportation system other than the vehicle to join and get into one vehicle 200 or a branching plan for allowing a plurality of users having gotten into one vehicle 200 to branch into transportation system other than the vehicle when the boarding request acquired by the acquirer 320 is realized.

### Third Embodiment

Hereinafter, differences between a third embodiment and the first embodiment will be mainly described. In the third embodiment, the vehicle allocation service providing device 300 adds content of a sub-request (a service request of a user different from a main user) using a route of the main user as a standard and corrects the route of the main user or resets the route of the main user.

In the first embodiment, the user transmits the boarding request to the vehicle allocation service providing device 300 and gets into the allocated vehicle, as described above. In the third embodiment, however, a user transmits a service request to a vehicle allocation service providing device 300B. The service request is a request for a user using a vehicle. The use of the vehicle is, for example, occupation of part of the vehicle by the user, getting into a vehicle, or loading luggage in a vehicle. The use of the vehicle is also, for example, calling a vehicle to a position (or near a position) designated by the user to meet a person getting into a vehicle or receive or inspect luggage loaded in a vehicle. In the first or second embodiment, the user may transmit a service request to the vehicle allocation service providing device 300. In this case, the vehicle allocation service providing device 300 provides a service to the user in response to the service request.

The service request includes a use condition and is registered as use condition information 385 in the storage 380, as shown in FIG. 22. The use condition information 385 is information in which a desired use location, a destination, a desired use time, desire information indicating a desire of the user, a vehicle allocate flag indicating whether allocate is determined (for example, 1 indicates that allocate is determined and 0 indicates that allocate is not determined), and the like are associated with a user ID which is identification information of a user registered in advance. The desire information is, for example, a desire for drop-off and pick-up to a branching or joining location, whether to ride together with a main user, the number of using persons, destination of a seat, occupation classification indicating a region (or a space) desired to be occupied in a vehicle, or the like. Content of the information other than the vehicle allocate flag is determined by causing a ridesharing application of the terminal device 100 to receive an input of the user and the information is transmitted as a service request to the vehicle allocation service providing device 300.

FIG. 22 is a diagram showing an example of a functional configuration of a vehicle allocation service providing device 300B according to a third embodiment. The vehicle allocation service providing device 300B includes a manager 330B instead of the service manager 330 of the vehicle allocation service providing device 300. The vehicle allocation service providing device 300B further includes a storage 380B instead of the storage 380 of the vehicle allocation service providing device 300. The storage 380 stores the above-described use condition information 385 instead of the boarding condition information 384.

The acquirer 320 of the vehicle allocation service providing device 300B acquires, for example, a service request (a use request) of the main user or a user (a sub-user) different from the main user. The manager 330B includes an instructor 331, a route setter 332, a service issuer 333, a service sharer 334, and a service manager 335.

For example, the instructor 331 instructs an automated driving vehicle of a route in response to the service request acquired by the acquirer 320. The route of the automated driving vehicle is a route determined by the route setter 332.

The route setter 332 performs setting the route of the automated driving vehicle based on the service request or the service request of the sub-user. The service request of the sub-user includes ID information issued by the service sharer 334 to be described below. The “route” may be a prescribed route or may be a route in which a predetermined location is passed near a set time.

The service issuer 333 issues a service to the main user. The service sharer 334 shares the ID information regarding the service with the sub-user in accordance with an intention of the main user. The sharing is, for example, transmission or provision of the ID information to the sub-user or receivability of a service by the sub-user.

The service manager 335 allocates a plurality of automated driving vehicles as relays to the main user based on either the joining plan for the main user and the sub-user to use the same vehicle on the route or the branching plan for the main user and the sub-user to ride separately into a plurality of vehicles from the route. With regard to the relay, a condition that a user necessarily gets into or out of a vehicle is not an essential condition, and the relay may be located within a predetermined distance between the user and the vehicle. For example, the service manager 335 allows the sub-user to occupy at least part of one vehicle of a plurality of automated driving vehicles in a state in which the main user does not use a vehicle based on information regarding the route set by the route setter 332.

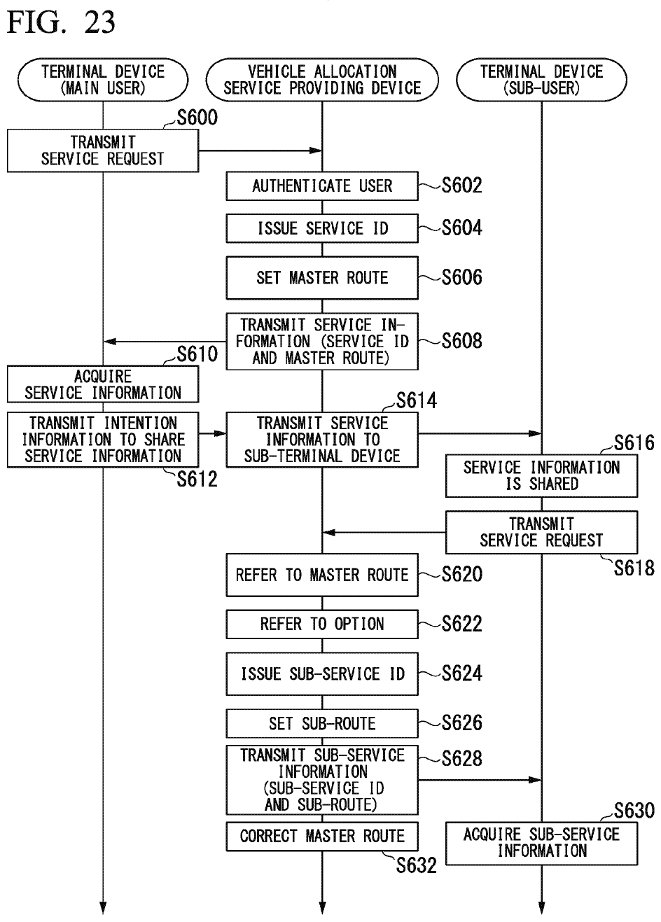

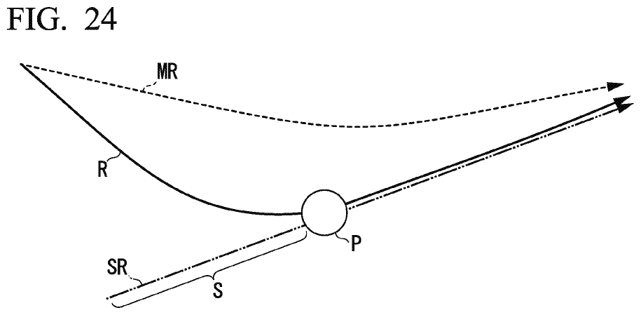

FIG. 23 is a sequence diagram showing an example of a flow of a process performed by the vehicle allocation service providing device 300B according to the third embodiment. First, a service request of the terminal device 100 carried by the main user (hereinafter referred to as a main terminal device) is transmitted to the vehicle allocation service providing device 300B (step S600).

Subsequently, the service issuer 333 authenticates the user ID included in the service request as a user ID registered in advance (step S602). The user ID to which a service can be provided is registered in advance in the storage 380B.

Subsequently, the service issuer 333 issues the service ID when the authentication of the user ID is established (step S604). The service ID is information indicating an authority for the user to receive a service.

Subsequently, the route setter 332 sets a master route based on the service request acquired in step S600 (step S606). The master route is a route along which a set vehicle to be allocated travels based on the service request of the user of the main terminal device 100. Subsequently, the manager 330B transmits the service ID issued in step S604 and information regarding the master route (hereinafter referred to as service information) set in step S606 to the main terminal device 100 (step S608).

Subsequently, the main terminal device 100 acquires the service information (step S610). Subsequently, when the user performs an operation of sharing the service information on the main terminal device 100, the main terminal device 100 transmits intention information indicating an intention to share the service information to the vehicle allocation service providing device 300B (step S612).

Subsequently, when the vehicle allocation service providing device 300B acquires the intention information, the service sharer 334 of the vehicle allocation service providing device 300B transmits the service information to the terminal device 100 of the sub-user (hereinafter referred to as sub-terminal device) (step S614). Subsequently, when the sub-terminal device 100 acquires the service information from the vehicle allocation service providing device 300B, the service information is shared (step S616).

It is assumed that the service sharer 334 transmits the service information to the terminal device 100 of the sub-user (hereinafter referred to as a sub-terminal device) and the service information is shared with the sub-terminal device 100. However, the main terminal device 100 may directly transmit the service information to the sub-terminal device 100 and the service information is shared with the sub-terminal device 100. Instead of the service information, the service ID may be transmitted to the sub-terminal device 100. In this case, the sub-terminal device 100 may request the vehicle allocation service providing device 300B to provide the service ID.

Subsequently, when the sub-user performs an operation of transmitting a service request on the sub-terminal device 100, the sub-terminal device 100 transmits the service request to the vehicle allocation service providing device 300B (step S618).

When the vehicle allocation service providing device 300B acquires the service request, the route setter 332 refers to the master route (step S620) and further refers to the service request and desire information which is an option included in the service request (step S622) to determine a joining location at which the main user and the sub-user join, means by which the sub-user arrives at the joining location, an assembly time at the joining location, and the like. The route setter 332 determines means by which the sub-user arrives at the joining location based on, for example, the desire information included in the service request. For example, when the sub-user desires for drop-off and pick-up to the joining location, the route setter 332 allocates another vehicle of the vehicle into which the main user gets for the sub-user. For example, when the sub-user moves to the joining location by himself or herself, the sub-user moves to the joining location by walk or public transportation system. Then, the service issuer 333 issues a sub-service ID with regard to the determined content (step S624).

Subsequently, the route setter 332 sets a sub-route which is a route of the sub-user (step S626). Subsequently, the manager 330B transmits sub-service information (the sub-service ID and the sub-route) to the sub-terminal device 100 (step S628). The sub-terminal device 100 acquires the sub-service information transmitted by the manager 330B (step S630). When the vehicle allocation service providing device 300B transmits the sub-service information to the sub-terminal device 100, the route setter 332 corrects the master route based on the sub-route (step S632). Then, the service manager 335 updates the service schedule based on the above-described process result.

FIG. 24 is a diagram showing an example of an aspect in which a main route is corrected by the vehicle allocation service providing device 300B. For example, the route setter 332 sets the master route MR based on the acquired service request. When the vehicle allocation service providing device 300B acquires the service request, the service issuer 333 refers to the master route and further refers to the service request and the desire information included in the service request to determine a joining location P at which the main user and the sub-user join, means by which the sub-user arrives at the joining location (movement means of a section S), an assembly time at the joining location, or the like. The joining location P is, for example, a location at which the main user and the sub-user can assembly reasonably. Subsequently, the route setter 332 sets the sub-route SR which is a route of the sub-user and corrects the master route based on the sub-route. Thus, the corrected master route R is set.

According to the above-described third embodiment, when the manager 330B sets the route of the main user and acquires the service request of the sub-user, the route is changed so that the main user and the sub-user can join based on the service request of the sub-user and move in a direction of the destination. As a result, it is possible to plan a more efficient service schedule.

According to the above-described embodiments, the vehicle allocation service providing device 300 includes: the acquirer 320 configured to acquire a use request of a main user; the instructor 331 configured to instruct an automated driving vehicle of a route in response to the use request acquired by the acquirer 320; the route setter 332 configured to set the route of the automated driving vehicle based on the use request and a use request of a user different from the main user; and the service manager 335 configured to allocate a plurality of automated driving vehicles as relays to the main user based on one of a joining plan for the main user and a user different from the main user to use the same vehicle on the route or a branching plan for the main user and the user different from the main user to ride separately into a plurality of vehicles on the route. Thus, it is possible to plan a more efficient service schedule.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, part or the entirety of the vehicle allocation service providing device 300 may be mounted on the vehicle 200.

When the vehicle 200 is a non-automated driving vehicle, the communicator 310 may communicate with a terminal device of a driver of the vehicle 200 via the network NW.

### Reference Signs List

1 Ridesharing system

100 Terminal device

200 Vehicle

300 Vehicle allocation service providing device

310 Communicator

320 Acquirer

330 Service manager

340 Authenticator

342 Non-automated driving permitter

350 Settler

380 Storage

388 Service schedule information

U User

What is claim is:

1. A vehicle allocation service providing device comprising:
an acquirer configured to acquire a use request of a main user;
an instructor configured to instruct an automated driving vehicle of a route in response to the use request acquired by the acquirer;
a route setter configured to set the route of the automated driving vehicle based on the use request and a use request of a user different from the main user; and
a service manager configured to allocate a plurality of automated driving vehicles as relays to the main user based on one of a joining plan for the main user and a user different from the main user to use the same vehicle on the route or a branching plan for the main user and the user different from the main user to ride separately into a plurality of vehicles on the route.

2. The vehicle allocation service providing device according to claim 1, wherein the service manager permits a situation in which a first user occupying at least part of a first automated driving vehicle among the plurality of automated driving vehicles and arriving at a joining location and a second user occupying at least part of a second automated driving vehicle among the plurality of automated driving vehicles and arriving at the joining location share at least part of one automated driving vehicle among the plurality of automated driving vehicles at the joining location.

3. The vehicle allocation service providing device according to claim 1, wherein the service manager permits a situation and determines a service schedule, the situation being a situation in which the first user occupies at least part of a first automated driving vehicle among the plurality of automated driving vehicles and the second user occupies at least part of a second automated driving vehicle among the plurality of automated driving vehicles at the branching location,. the first and the second users being users sharing at least part of one automated driving vehicle among the plurality of automated driving vehicles and arriving at a branching location.

4. The vehicle allocation service providing device according to claim 1,
wherein a medium reader reading information for settlement from a medium provided by a user is mounted on the plurality of automated driving vehicles, and
wherein the vehicle allocation service providing device further comprises a charging determiner configured to determine to charge the user based on the information read by the medium reader.

5. The vehicle allocation service providing device according to claim 1,
wherein a license reader reading license information from a license provided by a user is mounted on the plurality of automated driving vehicles, and
wherein the vehicle allocation service providing device further comprises a non-automated driving permitter configured to permit non-automated driving by the user based on the information read by the license reader.

6. The vehicle allocation service providing device according to claim 1, further comprising:
a service issuer configured to issue a service for the main user; and
a service sharer configured to share ID information regarding the service with the user different from the main user in accordance with an intention of the main user.

7. The vehicle allocation service providing device according to claim 1,
wherein a use request of a user different from the main user includes ID information issued by a service sharer configured to shares the ID information regarding a service for the main user with the user different from the main user in accordance with an intention of the main user,
wherein based on information regarding the route, the service manager allows the user different from the main user to occupy at least part of one vehicle among the plurality of automated driving vehicles in a state in which the main user does not use the vehicle.

8. A rideshare management method comprising:
acquiring a use request of a main user;
instructing an automated driving vehicle of a route in response to the acquired use request;
setting the route of the automated driving vehicle based on the use request and a use request of a user different from the main user; and
allocating a plurality of automated driving vehicles as relays to the main user based on one of a joining plan for the main user and a user different from the main user to use the same vehicle on the route or a branching plan for the main user and the user different from the main user to ride separately into a plurality of vehicles on the route.

9. A non-transitory computer-readable storage medium that stores a computer program to be executed by a computer to perform at least:
acquire a use request of a main user;
instruct an automated driving vehicle of a route in response to the acquired use request;
set the route of the automated driving vehicle based on the use request and a use request of a user different from the main user; and
allocate a plurality of automated driving vehicles as relays to the main user based on one of a joining plan for the main user and a user different from the main user to use the same vehicle on the route or a branching plan for the main user and the user different from the main user to ride separately into a plurality of vehicles on the route.
